(19) United States
(12) Patent Application Publication
(10) Pub. No.: US 2026/0224965 A1
(43) Pub. Date: Aug. 6, 2026

(54) GAME REGISTERING AND TRACKING SYSTEM AND APPARATUS

(71) Applicant: Tap to Play, LLC, Miami Beach, FL (US)

(72) Inventors: Leon Fernando Fiksman, Miami Beach, FL (US); Simon Carreño, Miami Beach, FL (US)

(73) Assignee: Tap to Play, LLC, Miami Beach, FL (US)

(21) Appl. No.: 19/042,599

(22) Filed: Jan. 31, 2025

(51) Int. Cl. A63B 71/06; G06F 1/16

(52) U.S. Cl. CPC A63B 71/0669; G06F 1/163

(57) ABSTRACT

A game tracking system for assisting in tracking scores on a court area for a game such as pickleball or tennis can include a wrist band having at least one actuator device, a wireless communication device on, in or coupled to the wrist band, and one or more processors coupled to the wireless communication device and to memory having computer code which when executed causes the one or more processors to perform certain operations. In some embodiments, the operations can include registering or identifying a player or team upon reaching within a predetermined proximity of the court area, and capturing or flagging game play highlights from a video recording of the game or incrementing or decrementing a score in the game in response to activation of the at least one actuator device. In some embodiments, a number of actuators enable flagging of highlights and score tracking.

### CROSS-REFERENCE TO RELATED APPLICATIONS

Not applicable

### BACKGROUND

The present disclosure is directed to an apparatus and system for tracking and registering players and games in games such as padel, pickleball or tennis.

### DESCRIPTION OF THE RELATED ART

Current methods to address some of the issues resolved by the current embodiments use devices that merely track player movements or steps, but fail to provide an integrated system that helps track scoring in a game or allow a participant or other observer to easily review a play or point.

With respect to pickleball, there are particular rules that make it a little different from tennis. Pickleball is a simple paddle game played with a baseball-sized wiffleball over a tennis-type net on a Badminton-sized court. Only the serving team or side can score points. Points are scored by legally serving a ball that is not returned by the opponent or by winning a rally. Games are normally played to 11 points and must be won by 2 points. There are other formats that may be used.

With respect to serving, the serve must be made with an underhand stroke so that contact with the ball is made below the waist level (navel) where the tip of paddle head remains below wrist and with the arm moving in an upward arc. The server must have at least one foot on the court surface behind the baseline on or within the imaginary lines extending from the centerline and the sideline at the time the ball is struck. A serve striking the net and landing within the service court is called a “let” and another serve is justified with no limit to the number of times this can occur. If a “let” serve hits the partner of the person receiving the serve before touching the court surface, the serve will be replayed as a let. If your serve hits either of your opponents before bouncing, it is a point for your team.

There is a Two-Bounce Rule where the serve and the service return must be allowed to bounce before striking the ball. That is, each side must play a groundstoke on the first shot following the serve. After the initial groundstrokes have been made, play may include volleys.

There are also serve sequence rules. For the team that starts the game, only one person gets to serve. The server always starts in the right-hand court and must serve crosscourt (to the backcourt diagonally opposite and beyond the non-volley zone line). The team member serving the initial serve of the game calls the score as “Zero, Zero, Two” meaning I have 0 points, you have 0 points, and I am the only server for this sequence so I'm the 2nd server.

After scoring a point, the server always re-positions to serve to the other court (changing places with their partner) for the next serve. You never serve to the same person or serving box twice in a row. Let's assume they score 2 points and then fault in some way.

When that first serving team faults, they transfer or “sideout” the serve to the opposing team. The opposing team begins their first serving sequence with the player who is standing on the right hand side of the court. They call the score as “Zero, two, one” (my score 0, your score 2, and first server). This team gets a service sequence of two faults (that is, each person serves until their team makes a fault or fails to score a point). Assume this team scores 2 points with their first server and then the team faults.

The team member serving the second serve must serve from whatever side they were playing (in this example, they are on the left side). They call the score as “Two, Two, Two” (my score 2, your score 2, and 2nd server). Service will then continue to alternate from side to side as long as the server continues to win points. Assume they score 3 more points. The serve now transfers (sideout) back to the original starting team and, from this point on, every service sequence will have both players completing their service turns. In this example, the score being called is now “Two, Five, One”.

The team's points will always be even numbers when that team's starting server is positioned on the right hand side of the court. Points will always be odd when the starting server is on the left hand side of the court.

There are also Non-Volley one rules or NVZ rules. The NVZ is the rectangular court surface bounded by the sidelines, the NVZ line, and the net. The air space above the surface of this area is not part of the NVZ. A fault will be declared if a player, player's clothing, or paddle touches the court within the non-volley zone while volleying the ball. A fault will be declared if, in the act of volleying the ball a player's momentum causes the player, clothing, or paddle to touch the court within the NVZ, even after play has stopped. There is no time limit regarding this momentum, it only ends when the players has regained control over the momentum. Players may enter the NVZ at any time as long as they are not or have not hit the ball as a volley. Jumping over the NVZ to the out-of-bounds area when volleying a ball is allowed. The lines do not extend upward. Note, it is not a fault if a player steps into the NVZ when hitting a ball that has bounced.

All faults, including foot faults; touching the net or post; double bounce; ball touching player or clothing in the air; violations of any rule; can be called by either team. When a server's foot encroaches the court area or is outside the imaginary extension of the sideline and centerline. Net support post: Any ball hitting the side posts is a dead ball fault. Catching the ball, getting hit: It is a fault to catch the ball and claim it was going out. The ball must bounce on the court surface without interference. If the ball touches a player prior to bouncing, whether you are inside or outside the court boundaries, it is a fault. All NVZ violations are faults.

Other basic rules include hand hitting the ball where balls hit by the paddle hand below the wrist while holding the paddle, are legal. It is a fault if a ball hits any other part of the body. An “out” ball is not “out” until it bounces. Never catch it or let it hit you in the air. Double/Carry Hits where a ball hit during one continuous single direction stroke is legal, even though the ball may be unintentionally hit twice or “carried”. The paddle may be switched from hand to hand at any time. Two-handed shots are also legal.

If the ball bounces onto your side of the court and spins back over the net, you may reach over the net (ie. breaking the plane of the net) to hit the ball. It is considered a valid return as long as you or your paddle does not touch the net.

A player can call the ball “out” as their partner is hitting the ball as long as the call is made immediately. If you want to tell your partner to not hit the ball, yell “bounce it”, “let it go”, “no”, or “out”. Saying “out” before the ball touches the court is deemed communication between the players. Saying out after the ball touches the court is deemed an “out” call and stops play.

Around the net it is not a fault if a ball being played lands in the opponent's court by traveling around the post and not passing directly over the net.

All rules for doubles play apply to singles play with the following exception: When serving in singles, each player serves from the RIGHT HAND court when the score is “0” or an even number, and from the LEFT HAND court when the score is “1, 3, 5, etc. or an odd number.

Playing Pickleball is a friendly and social game and we demand a code of ethical and proper manners at all times. Those people who abuse our conduct of play can receive everything from a warning to the extreme case of being banned from the CTPA and tournaments. Line calling is based on the honor system and good sportsmanship. Calling a ball out is usually deferred to the closest player with the best visual angle. Questionable calls should be in favor of your opponents. When you request an opinion of an opponent, accept the opinion of that player. The ball travels quickly. Players should try to make the fairest call that they can, and always respect the call made by the player who is closer to the ball. Bad calls happen and everyone makes them on occasion, but technology can also help.

Padel is a team sport where a couple competes against another couple. Padel uses the scoring system of tennis. Matches are played to the best of 3 sets. The games follow the score of 15, 30, 40, Advantages and/or Equals. Since 2020, the use of golden point at 40-40 has been implemented in the professional circuit. As in tennis, the players change side courts in the odd games. Thus, the players change sides with 1-0, 2-1, 3-2, 4-3, 5-4 . . . 3. The ball can be hit indistinctly by any player in any zone of the court. In padel, for the ball to be considered good it must touch the ground before hitting the walls or fences. The only exception is with the serve, where the ball can only hit the wall after the bounce, never the fence. During the course of a point the ball may hit the walls and fences. The player may hit the ball with or without a bounce depending on the situation of the point.

The correct padel serve is one of the most important rules of padel. The serve is considered good if the ball bounces inside the corresponding cross-quadrant. As in tennis, the serve must be crossed, that is to say, the player serving from the right half of their court must direct the serve towards the square to their left in the opponent's court. Unlike tennis, the ball is not thrown over the head to serve. In padel, the player must bounce the ball and can't hit it above the waist. The serve can go to any area of the opponent's square but can never hit the side fence after the bounce. On each service there are two opportunities to put the ball in play, that means if the player missed their first service on the net or the ball bounces out, the player will still have another chance. When the ball touches the net after the serve and goes to the other side of the court, there are several situations:

If after touching the net, the ball does not bounce in the corresponding square it will always be bad. If after touching the net, the ball bounces in the corresponding square these situations can happen:

The ball bounces once and does not touch the side fence, then it is considered null and the player has the right to repeat that service.

If the ball bounces twice and touches the side fence, it is considered null and the player has the right to repeat that service.

If the ball bounces once and touches the side fence, it is considered bad and the player is not entitled to repeat that service.

Hitting the ball twice in the same shot is not allowed. Players are not allowed to play without adjusting the safety rope of the racket. If the opponent hits the ball hard, the ball bounces and goes out of the court, the point is considered won by the player who hit it. However, players always have the chance hit it from outside to the opponent's side before the second bounce. When the ball bounces, touches the wall or fence and returns to the opponent's court, the point is considered won by the player who hit it although the players have the option to “safe” the point and hit the ball again even when it has crossed the net line into the opponent size of the court. If the net is touched with the racket, clothes or any part of the player's body while playing any point, the point is won by my opponent.

### BRIEF DESCRIPTION OF THE DRAWINGS

FIG. 1 illustrates a wrist band for use in a game for tracking scores and flagging highlights in accordance with the embodiments.

FIG. 2 illustrates a system for tracking scoring and reviewing highlights in a game in accordance with the embodiments;

FIG. 3A illustrates another wrist band for use in a game for at least flagging highlights in accordance with the embodiments;

FIG. 3B illustrates another wrist band for use in a game for at least flagging highlights and providing a display in accordance with the embodiments;

FIG. 4A illustrates another wrist band for use in a game for at least tracking scores in accordance with the embodiments;

FIG. 4B illustrates a smart watch that can be used with the system of FIG. 2 in accordance with the embodiments;

FIG. 5A illustrates a top view of a detachable unit used for tracking scores and flagging highlights in accordance with the embodiments.

FIG. 5B is a side view of the detachable unit of FIG. 5A in accordance with the embodiments;

FIG. 5C is a front view of the detachable unit of FIG. 5A in accordance with the embodiments;

FIG. 5D is a rear view of the detachable unit of FIG. 5A in accordance with the embodiments;

FIG. 5E is a front view of a wristband that can be used with the detachable unit of FIG. 5A in accordance with the embodiments;

FIG. 5F is a side view of the wristband of FIG. 5E;

FIG. 5G is a front view of the detachable unit of FIG. 5A coupled with the wristband of FIG. 5E in accordance with the embodiments; and

FIG. 5H is a side view of the detachable unit of FIG. 5A coupled with the wristband of FIG. 5E in accordance with the embodiments.

FIG. 6 illustrates a block diagram of a system in accordance with the embodiments; and

FIG. 7 illustrates a flow chart of a method in accordance with the embodiments.

### SUMMARY

In some embodiments, a game tracking system for assisting in tracking scores on a court area for a game such as padel, pickleball or tennis can include a wrist band having at least one actuator device, a wireless communication device on, in or coupled to the wrist band, and one or more processors coupled to the wireless communication device and to memory having computer code which when executed causes the one or more processors to perform certain operations. In some embodiments, the operations can include registering or identifying a player or team upon reaching within a predetermined proximity of the court area, and capturing or flagging game play highlights from a video recording of the game or increment or decrement a score in the game in response to activation of the at least one actuator device. Note that the embodiments are not necessarily limited to pickleball or tennis. Other individual or team sports such as basketball, volleyball, and badminton can also use the technology in accordance with the embodiments claimed.

In some embodiments, the wrist band has one actuator device in the form of a button used for capturing or flagging game play highlights from the video recording. Although buttons are disclosed as the actuator device, other actuator devices such as clickable rollerballs, multiway buttons, and touchscreens and the like are also contemplated within the scope of the embodiments.

In some embodiments, the wrist band has two actuator devices in the form of buttons used for incrementing and decrementing the score in the game.

In some embodiments, the wrist band has three actuator devices in the form of buttons used for incrementing and decrementing the score in the game and an additional button used for capturing or flagging game play highlights from the video recording.

In some embodiments, the wristband further includes a display. In some embodiments, the wristband includes a display for viewing captured or flagged game play highlights. As noted above, the display can be a touchscreen in some embodiments.

In some embodiments, the system further includes one or more cameras mounted in the court area. The cameras can be activated by motion or by intelligently monitoring game play in order to record any pertinent activity.

In some embodiments, the wristband is a smart watch which can also perform some or all of the functions previously discussed above.

In some embodiments, the wireless communication device is a near-field communication (NFC) device. In some embodiments, the wireless communication device is a Bluetooth communication device. The embodiments are not necessarily limited to NFC and Bluetooth and other wireless communication protocols are contemplated within the scope of the embodiments such as WiFi, Zigbee, cellular, and the like.

In some embodiments, the one or more processors uses artificial intelligence in combination with one or more cameras mounted in the court area to automatically determine point scoring. The embodiments can utilize a set of rules for the game and further utilize machine learning for certain actions corresponding to the rules to determine scoring in an automated fashion.

In some embodiments, a game tracking system for assisting in tracking scores on a court area for a game can include a wrist band having at least one actuator device, a wireless communication device on, in or coupled to the wrist band, and one or more processors coupled to the wireless communication device and to memory having computer code which when executed causes the one or more processors to perform certain operations. In some embodiments, the operations can include registering or identifying a player or team upon reaching within a predetermined proximity of the court area, and capturing or flagging game play highlights from a video recording of the game in response to activation of the at least one actuator device.

In some embodiments, the system further includes a second actuator device for incrementing a score in the game and a third actuator for decrementing the score in the game. Alternatively, a second actuator device can use a multi-position or toggle switch (that moves up and down or side to side) to alone perform the function of incrementing and decrementing a score.

In some embodiments, the wristband further includes a display for viewing captured or flagged game play highlights. In some embodiments, the display can be or include an actuator device such as a touchscreen that can also perform some or all of the functions such and incrementing or decrementing the score or flagging certain game play moments or highlights.

In some embodiments, the system further includes one or more cameras mounted in the court area for monitoring and recording game play.

In some embodiments, the wristband is a smart watch. The smart watch can work in conjunction with the system and perform some or all of the aforementioned functions.

In some embodiments, the one or more processors uses artificial intelligence in combination with one or more cameras mounted in the court area to automatically determine point scoring.

In some embodiments, a game tracking system for assisting in tracking scores on a court area for a game can include a wrist band having at least one actuator device, a wireless communication device on, in or coupled to the wrist band, a second wireless communication device arranged in the court area, one or more cameras mounted in the court area, and one or more processors coupled to the wireless communication device and to memory having computer code which when executed causes the one or more processors to perform certain operations. In some embodiments, the operations can include registering or identifying a player or team upon reaching within a predetermined proximity of the second wireless communication device in the court area, and capturing or flagging game play highlights from a video recording of the game in response to activation of the at least one actuator device.

In some embodiments, the wristband further includes a display for viewing captured or flagged game play highlights.

In some embodiments, the one or more processors uses artificial intelligence in combination with one or more cameras mounted in the court area to automatically determine point scoring including the determination of violations of rules of the game or whether balls fell within or outside the area of game play that would be a part of the process of point scoring.

### DETAILED DESCRIPTION

The embodiments disclosed herein introduce a smart and intuitive system for tracking either individual players or players on a team in a competition or game such as padel, pickleball or tennis. The system can easily be adapted for other games such as handball, basketball, soccer, volleyball, football and the like. Generally, players can use their bracelets or smartwatches to perform several functions, including, but not limited to registering or identifying their team by tapping their bracelet on a sensor that ideally using near field communications (NFC) or other wireless protocols such as Bluetooth or WiFi to name a few.

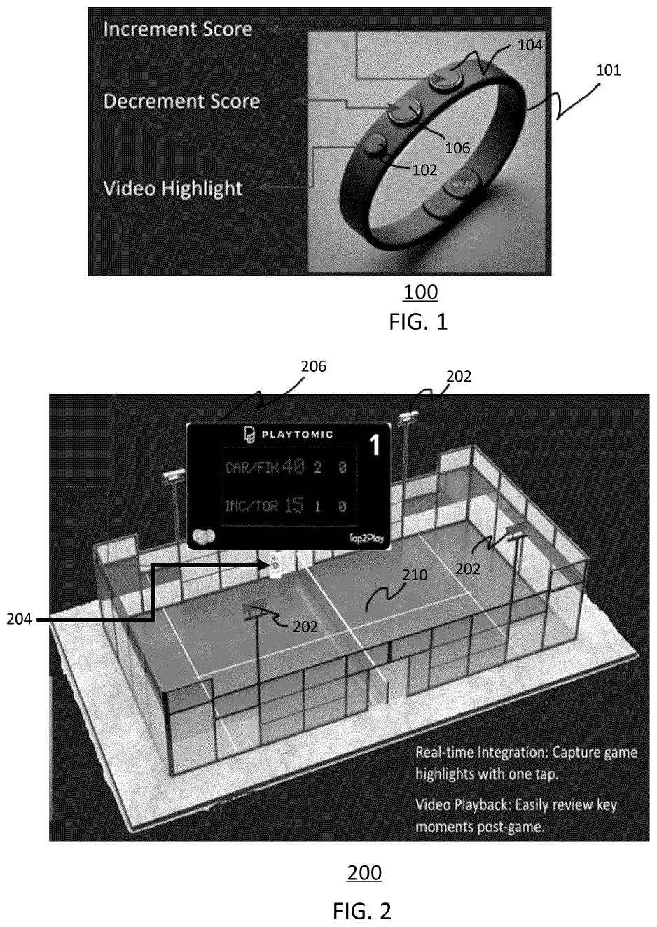

In some embodiments as shown in FIG. 1, a game tracking system 100 for assisting in tracking scores on a court area for a game such as pickleball or tennis can include a wrist band 101 having at least one actuator device 102, a wireless communication device on, in or coupled to the wrist band, and one or more processors coupled to the wireless communication device and to memory having computer code which when executed causes the one or more processors to perform certain operations. In some embodiments, the operations can include registering or identifying a player or team upon reaching within a predetermined proximity of the court area, and capturing or flagging game play highlights from a video recording of the game or increment or decrement a score in the game in response to activation of the at least one actuator device. Note that the embodiments are not necessarily limited to padel, pickleball or tennis. Other individual or team sports such as basketball, volleyball, and badminton can also use the technology in accordance with the embodiments claimed. In some embodiments, the at least one actuator 102 is used to capture or flag game paly highlights from a video recording. In some embodiments, other actuators such as actuators 104 and 106 can be used to increment or decrement the score in the game.

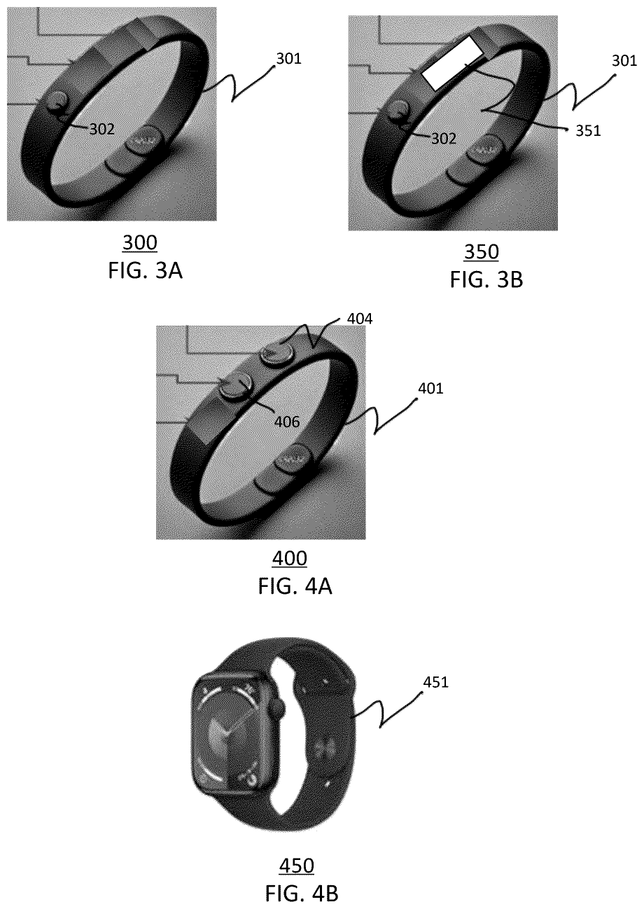

In some embodiments, a wrist band (101 in FIG. 1 or 301 in system 300 of FIG. 3A) has one actuator device (102 or 302) in the form of a button used for capturing or flagging game play highlights from the video recording. Although buttons are disclosed as the actuator device, other actuator devices such as clickable rollerballs, multiway buttons, toggle switches, and touchscreens and the like are also contemplated within the scope of the embodiments.

In some embodiments, a wrist band (101 in FIG. 1 or 401 in in system 400 of FIG. 4A) has two actuator devices (104 and 106 in FIG. 1 or 404 and 406 in FIG. 4A) in the form of buttons used for incrementing and decrementing the score in the game.

In some embodiments, the wrist band has three actuator devices in the form of buttons (104 and 106) used for incrementing and decrementing the score in the game and an additional button (102) used for capturing or flagging game play highlights from the video recording.

In some embodiments, a wristband 301 (of a system 350 of FIG. 3B) further includes a display 351. In some embodiments, the wristband includes a display for viewing captured or flagged game play highlights. As noted above, the display can be a touchscreen in some embodiments.

In some embodiments, the system as shown in system 200 of FIG. 2 further includes one or more cameras 202 mounted in a court area 210. The cameras can be activated by motion or by intelligently monitoring game play (in accordance with game rules) in order to record any pertinent activity.

In some embodiments, the wristband is a smart watch 450 as shown in FIG. 4B which can also perform some or all of the functions previously discussed above.

In some embodiments, the wireless communication device in the wristband 201 is a near-field communication (NFC) device that communicates with another wireless communication device in the court area 210 of FIG. 2. In some embodiments, the wireless communication device(s) is a Bluetooth communication device. The embodiments are not necessarily limited to NFC and Bluetooth and other wireless communication protocols are contemplated within the scope of the embodiments such as WiFi, Zigbee, cellular, and the like.

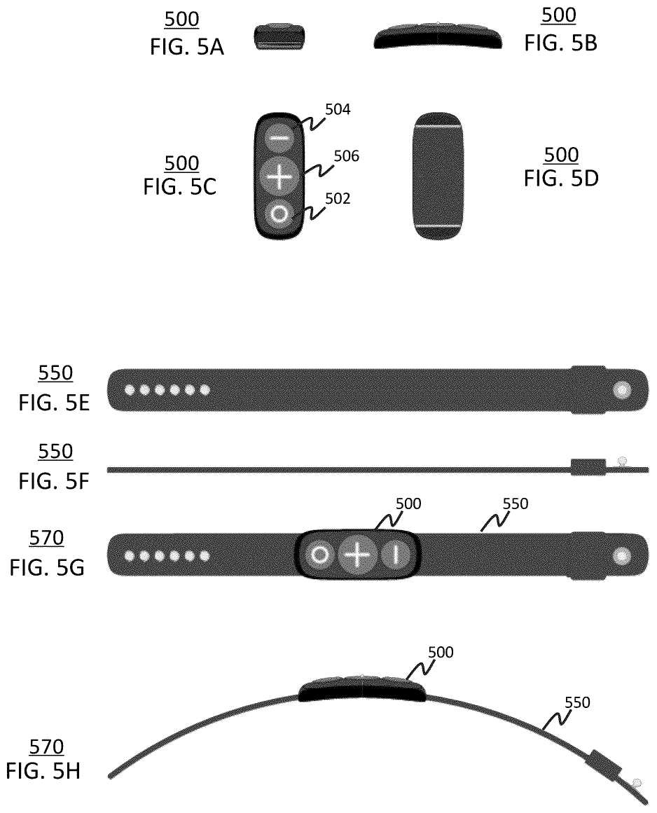

In some embodiments, as shown in FIGS. 5A through 5H, a system 500 can come in the form of a detachable unit that includes the one, two or three actuator devices or buttons to perform the various functions previously described above. For example, the actuator device 502 can be used to flag highlights and the actuator devices 504 and 506 can be used decrement or increment the scores as needed as shown in FIG. 5C. The detachable device can attach to various items including a wrist strap 550 as shown in FIGS. 5E and 5F. In FIGS. 5G and 5H, the detachable device 500 in combination with the wrist strap 550 forms the combination system 570.

In some embodiments, the one or more processors uses artificial intelligence in combination with one or more cameras (202) mounted in the court area 210 to automatically determine point scoring. The embodiments can utilize a set of rules for the game and further utilize machine learning for certain actions corresponding to the rules to determine scoring in an automated fashion. Correspondingly, an application or mobile app can have a user interface 206 that presents game scoring listing the team or players for the team, the score, and the current player serving in the case of pickleball.

Operationally, the players can tap their bands or bracelets on a surface or wireless device 204 to initially identify their team or a player. During gameplay, the players can use buttons on their bands/bracelets or smartwatch to increment or decrement a score and mark or flag highlights. The system provides real-time integration by capturing game highlights with a single actuation or tap. The system can further use video playback to easily review key moments after the game or even review questionable calls during a game.

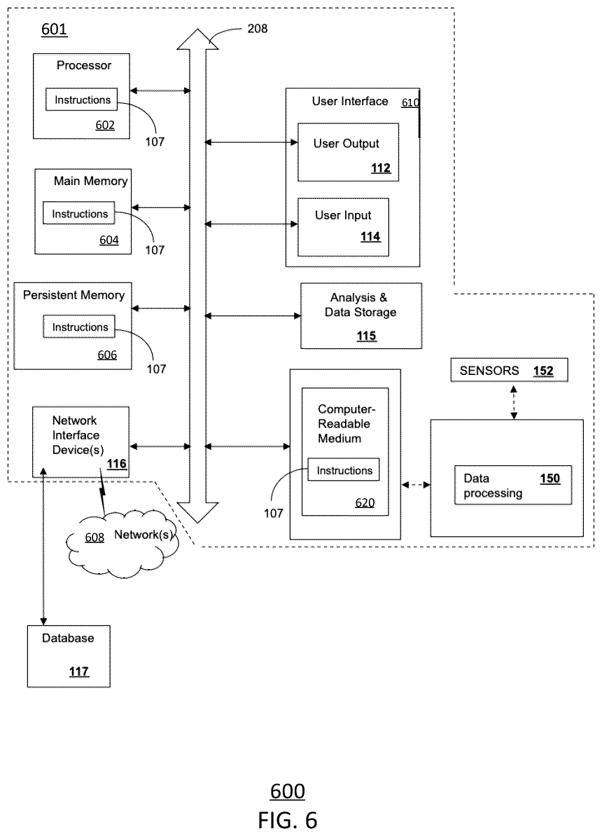

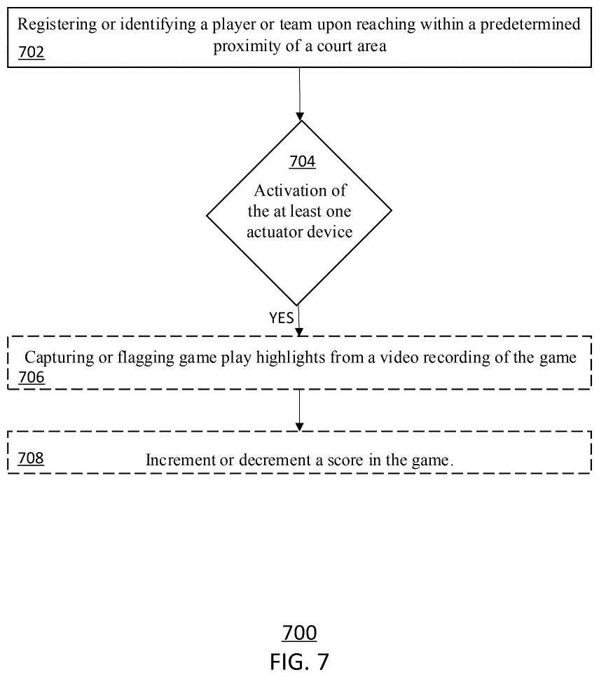

In some embodiments, a game tracking system (100, 300, or 350) for assisting in tracking scores on a court area 210 for a game can include a wrist band (101 or 301) having at least one actuator device, a wireless communication device on, in or coupled to the wrist band, and one or more processors (602 of FIG. 6) coupled to the wireless communication device (116 and 608) and to memory having computer code which when executed causes the one or more processors to perform certain operations. In some embodiments (as shown in method 700 of FIG. 7), the operations can include registering or identifying (702) a player or team upon reaching within a predetermined proximity of the court area, and capturing or flagging (706) game play highlights from a video recording of the game in response to activation of the at least one actuator device at step 704.

In some embodiments, the system or method 700 further includes a second and/or third actuator device for incrementing and/or decrementing (708) a score in the game. Alternatively, a second actuator device can use a multi-position or toggle switch (that moves up and down or side to side) to alone perform the function of incrementing and decrementing a score.

In some embodiments, the wristband further includes a display for viewing captured or flagged game play highlights. In some embodiments, the display can be or include an actuator device such as a touchscreen that can also perform some or all of the functions such and incrementing or decrementing the score or flagging certain game play moments or highlights.

In some embodiments, the system 200 as shown in FIG. 2 further includes one or more cameras 202 mounted in the court area 210 for monitoring and recording game play.

In some embodiments, the wristband 500 is a smart watch as shown in FIG. 5. The smart watch can work in conjunction with the system (200) and perform some or all of the aforementioned functions.

In some embodiments, the one or more processors (602, see FIG. 6) uses artificial intelligence in combination with one or more cameras (202) mounted in the court area to automatically determine point scoring.

In some embodiments with references to FIGS. 1-7, a game tracking system (100, 200, 300, 350, 400, 450, 500, 570 or 600) for assisting in tracking scores on a court area for a game can include a wrist band (101, 301, 401, 451, 570 or 601) having at least one actuator device (102 or 302 or 114), a wireless communication device (116) on, in or coupled to the wrist band, a second wireless communication device (204) arranged in the court area (210), one or more cameras 202 mounted in the court area, and one or more processors 602 coupled to the wireless communication device and to memory (604, 606, and/or 620) having computer code (107) which when executed causes the one or more processors to perform certain operations. In some embodiments, the operations can include registering or identifying (702) a player or team upon reaching within a predetermined proximity of the second wireless communication device in the court area, and capturing or flagging (706) game play highlights from a video recording of the game in response to activation (704) of the at least one actuator device.

In some embodiments, the wristband further includes a display (351) for viewing captured or flagged game play highlights.

In some embodiments, the one or more processors (602) uses artificial intelligence in combination with one or more cameras (202) mounted in the court area 210 to automatically determine point scoring including the determination of violations of rules of the game or whether balls fell within or outside the area of game play that would be a part of the process of point scoring.

In some embodiments, and with further references to FIG. 6, a game tracking system 600 for assisting in tracking scores on a court area for a game such as pickleball or tennis can include any number and combination of the previously described components above as well as one or more processors which when executing the computer instructions, performs one or more of the functions of described above. Obviously, if a game has different rules or variations, the computer instructions can be modified accordingly within contemplation of the embodiments herein.

In some embodiments, the system can utilize artificial intelligence and more particularly machine learning which can use exemplary training data and/or actual commercial use data to further refine what is intended to serve as an exemplary repetition based on a particular environment or a number of known environments. Machine learning is a method of data analysis that automates analytical model building. It is a branch of artificial intelligence based on the idea that systems can learn from data, identify patterns and make decisions with minimal human intervention. Some of the training data that can be used to help identify patterns and make decisions can include fields such as identity codes, scheduling data, location data and/or other parameters obtained from sensors such as cameras, video monitoring devices, audio devices, temperature or other sensor data that can be programmatically configured to more adequately and accurately reflect real world conditions as a system is utilized in a particular environment and hopefully across different environments. Ideally, using machine learning enables systems to automatically learn and improve from experience without being explicitly programmed. Machine learning in the embodiments herein can focus on the development of computer programs (using the Python programming language, for example) to access data and use it to learn for itself in order to better predict when a repetition of an exercise is performed or when it is not fully completed.

In some embodiments, the system can be a client device having one or more computer storage mediums containing computer instructions enabling secure access, storage, transport, and tracking of electronically tagged objects, one or more processors operationally coupled to the one or more computer storage mediums where the one or more processors perform the operations described above.

In some embodiments, the system can further include a computer-storage media coupled to a processor (or processors) and computer-executable instructions embodied in the computer-storage media that, when executed by one or more computing devices, perform a method that perform any number of steps such as performing the method of game tracking herein.

Various embodiments of the present disclosure can be implemented on an information processing system. The information processing system is capable of implementing and/or performing any of the functionality set forth above. Any suitably configured processing system can be used as the information processing system in embodiments of the present disclosure. The information processing system is operational with numerous other general purpose or special purpose computing system environments, networks, or configurations. Examples of well-known computing systems, environments, and/or configurations that may be suitable for use with the information processing system include, but are not limited to, personal computer systems, server computer systems, thin clients, hand-held or laptop devices, notebook computing devices, multiprocessor systems, mobile devices, microprocessor-based systems, set top boxes, programmable consumer electronics, network PCs, minicomputer systems, mainframe computer systems, Internet-enabled television, and distributed cloud computing environments that include any of the above systems or devices, and the like. As noted previously, the data processing can be any number of data processing techniques suited for tracking certain game play.

For example, a user with a mobile device may be in communication with a server configured to implement the system using the aforementioned elements, according to an embodiment of the present disclosure. The mobile device can be, for example, a multi-modal wireless communication device, such as a “smart” phone, configured to store and execute mobile device applications (“apps”). Such a wireless communication device communicates with a wireless voice or data network using suitable wireless communications protocols.

The system may include, inter alia, various hardware components such as processing circuitry executing modules that may be described in the general context of computer system-executable instructions, such as program modules, being executed by the system. Generally, program modules can include routines, programs, objects, components, logic, data structures, and so on that perform particular tasks or implement particular abstract data types. The modules may be practiced in various computing environments such as conventional and distributed cloud computing environments where tasks are performed by remote processing devices that are linked through a communications network. In a distributed cloud computing environment, program modules may be located in both local and remote computer system storage media including memory storage devices. Program modules generally carry out the functions and/or methodologies of embodiments of the present disclosure, as described above.

In some embodiments, a system includes at least one memory and at least one or more processor of a computer system communicatively coupled to the at least one memory. The at least one processor can be configured to perform a method including methods described above.

According to yet another embodiment of the present disclosure, a computer readable storage medium comprises computer instructions which, responsive to being executed by one or more processors, cause the one or more processors to perform operations as described in the methods or systems above or elsewhere herein.

As shown in FIG. 6, an information processing system 601 of a system 600 can be communicatively coupled with the data processing module 150 and a group of client or other devices, or coupled to a presentation device for display at any location at a terminal or server location. According to this example, at least one processor 602, responsive to executing instructions 107, performs operations to communicate with the processing module 150 via a bus architecture 208, as shown. The at least one processor 602 is communicatively coupled with main memory 604, persistent memory 606, and a computer readable medium 620. The processor 602 is communicatively coupled with an Analysis & Data Storage 115 that, according to various implementations, can maintain stored information used by, for example, the data processing module 150 and more generally used by the information processing system 600. The data processing module 150 can be coupled to one or more sensors 152 as needed. Such sensors can be barcode scanners, fingerprint readers, proximity sensors, microphones, cameras, video cameras, location sensors, motion detectors, scales, tension sensors, biometric reading devices (e.g., iris scanners, facial recognition scanners, voice detection devices) and other devices as contemplated herein. Optionally, this stored information can be received from the client or other devices. For example, this stored information can be received periodically from the client devices and updated or processed over time in the Analysis & Data Storage 115. Additionally, according to another example, a history log can be maintained or stored in the Analysis & Data Storage 115 of the information processed over time. The data processing module 150, and the information processing system 600, can use the information from the history log such as in the analysis process and in making decisions related to a particular user's access or for logging electronically tagged objects according to a database of best practices for a particular procedure or procedures.

The computer readable medium 620, according to the present example, can be communicatively coupled with a reader/writer device (not shown) that is communicatively coupled via the bus architecture 208 with the at least one processor 602. The instructions 107, which can include instructions, configuration parameters, and data, may be stored in the computer readable medium 620, the main memory 604, the persistent memory 606, and in the processor's internal memory such as cache memory and registers, as shown.

The information processing system 600 includes a user interface (or interfaces) 610 that comprises a user output interface 112 and user input interface 114. Examples of elements of the user output interface 112 can include a display, a speaker, one or more indicator lights, one or more transducers that generate audible indicators, and a haptic signal generator or any of the interfaces illustrated or discussed with respect to the figures or elsewhere in the application. Examples of elements of the user input interface 114 can include a button, a toggle switch, a keyboard, a keypad, a mouse, a track pad, a touch screen, a touch pad, a microphone that receives audio signals, a camera, a video camera, a CT-Scanner, or any other scanner that scans images. Some user inputs can be sensors or vice-versa. The received audio signals or scanned images, for example, can be converted to electronic digital representations and stored in memory, and optionally can be used with corresponding voice or image recognition software executed by the processor 602 to receive user input data and commands, or to receive test data for example. The voice recognition software can be used to enter or check off items on a checklist and further provide data or text entry or commands allowing the user to enter notes or data as needed.

A network interface device 116 is communicatively coupled with the at least one processor 602 and provides a communication interface for the information processing system 600 to communicate via one or more networks 608. The networks 608 can include wired and wireless networks, and can be any of local area networks, wide area networks, or a combination of such networks. For example, wide area networks including the internet and the web can inter-communicate the information processing system 600 with other one or more information processing systems that may be locally, or remotely, located relative to the information processing system 600. It should be noted that mobile communications devices, such as mobile phones, Smart phones, tablet computers, lap top computers, and the like, which are capable of at least one of wired and/or wireless communication, are also examples of information processing systems within the scope of the present disclosure. The network interface device 116 can provide a communication interface for the information processing system 600 to access the at least one database 117 according to various embodiments of the disclosure.

The instructions 107, according to the present example, can include instructions for monitoring, instructions for analyzing, instructions for retrieving and sending information and related configuration parameters and data. It should be noted that any portion of the instructions 107 can be stored in a centralized information processing system or can be stored in a distributed information processing system, i.e., with portions of the system distributed and communicatively coupled together over one or more communication links or networks.

FIGS. 1-7 illustrate examples of systems, methods or process flows, according to various embodiments of the present disclosure, which can operate in conjunction with the information processing system 600 of FIG. 6.

1. A game tracking system for assisting in tracking scores on a court area for a game, comprising:
a wrist band having at least one actuator device;
a wireless communication device on, in or coupled to the wrist band; and
one or more processors coupled to the wireless communication device and to memory having computer code which when executed causes the one or more processors to perform the operations of:
register or identify a player or team upon reaching within a predetermined proximity of the court area; and
in response to activation of the at least one actuator device, capture or flag game play highlights from a video recording of the game or increment or decrement a score in the game.

2. The game tracking system of claim 1, wherein the wrist band has one actuator device in the form of a button used for capturing or flagging game play highlights from the video recording.

3. The game tracking system of claim 1, wherein the wrist band has two actuator devices in the form of buttons used for incrementing and decrementing the score in the game.

4. The game tracking system of claim 1, wherein the wrist band has three actuator devices in the form of buttons used for incrementing and decrementing the score in the game and an additional button used for capturing or flagging game play highlights from the video recording.

5. The game tracking system of claim 1, wherein the wristband further comprises a display.

6. The game tracking system of claim 1, wherein the wristband further comprises a display for viewing captured or flagged game play highlights.

7. The game tracking system of claim 1, wherein the system further comprises one or more cameras mounted in the court area.

8. The game tracking system of claim 1, wherein the wristband is a smart watch.

9. The game tracking system of claim 1, wherein the wireless communication device is a near-field communication (NFC) device.

10. The game tracking system of claim 1, wherein the wireless communication device is a Bluetooth communication device.

11. The game tracking system of claim 1, wherein the one or more processors uses artificial intelligence in combination with one or more cameras mounted in the court area to automatically determine point scoring.

12. A game tracking system for assisting in tracking scores on a court area for a game, comprising:
a wrist band having at least one actuator device;
a wireless communication device on, in or coupled to the wrist band; and
one or more processors coupled to the wireless communication device and to memory having computer code which when executed causes the one or more processors to perform the operations of:
register or identify a player or team upon reaching within a predetermined proximity of the court area;
in response to activation of the at least one actuator device, capture or flag game play highlights from a video recording of the game.

13. The game tracking system of claim 12, wherein the system further comprises a second actuator device for incrementing a score in the game and a third actuator for decrementing the score in the game.

14. The game tracking system of claim 12, wherein the wristband further comprises a display for viewing captured or flagged game play highlights.

15. The game tracking system of claim 12, wherein the system further comprises one or more cameras mounted in the court area.

16. The game tracking system of claim 12, wherein the wristband is a smart watch.

17. The game tracking system of claim 12, wherein the one or more processors uses artificial intelligence in combination with one or more cameras mounted in the court area to automatically determine point scoring.

18. A game tracking system for assisting in tracking scores on a court area for a game, comprising:
a wrist band having at least one actuator device;
a wireless communication device on, in or coupled to the wrist band;
a second wireless communication device arranged in the court area;
one or more cameras mounted in the court area; and
one or more processors coupled to the wireless communication device and to memory having computer code which when executed causes the one or more processors to perform the operations of:
register or identify a player or team upon reaching within a predetermined proximity of the second wireless communication device in the court area;
in response to activation of the at least one actuator device, capture or flag game play highlights from a video recording of the game.

19. The game tracking system of claim 18, wherein the wristband further comprises a display for viewing captured or flagged game play highlights.

20. The game tracking system of claim 18, wherein the one or more processors uses artificial intelligence in combination with one or more cameras mounted in the court area to automatically determine point scoring.
